(19) United States
(12) Patent Application Publication
(10) Pub. No.: US 2023/0072432 A1
(43) Pub. Date: Mar. 9, 2023

(54) APPARATUS AND METHOD FOR ACCELERATING DEEP NEURAL NETWORK LEARNING FOR DEEP REINFORCEMENT LEARNING

(71) Applicant: Korea Advanced Institute of Science and Technology, Daejeon (KR)

(72) Inventors: Hoi Jun YOO, Daejeon (KR); Juhyoung LEE, Daejeon (KR)

(73) Assignee: Korea Advanced Institute of Science and Technology, Daejeon (KR)

(21) Appl. No.: 17/898,553

(22) Filed: Aug. 30, 2022

(30) Foreign Application Priority Data
Aug. 31, 2021 (KR) 10-2021-0115900

(51) Int. Cl. G06N 3/08

(52) U.S. Cl. CPC G06N 3/082

(57) ABSTRACT

Provided is a deep neural network (DNN) learning accelerating apparatus for deep reinforcement learning, the apparatus including: a DNN operation core configured to perform DNN learning for the deep reinforcement learning; and a weight training unit configured to train a weight parameter to accelerate the DNN learning and transmit it to the DNN operation core, the weight training unit including: a neural network weight memory storing the weight parameter; a neural network pruning unit configured to store a sparse weight pattern generated as a result of performing the weight pruning based on the weight parameter; and a weight prefetcher configured to select/align only pieces of weight data of which values are not zero (0) from the neural network weight memory using the sparse weight pattern and transmit the pieces of weight data of which the values are not zero to the DNN operation core.

### CROSS-REFERENCE TO RELATED APPLICATION

This application claims the benefit of Korean Patent Application No. 10-2021-0115900 filed on Aug. 31, 2021, in the Korean Intellectual Property Office, the entire disclosure of which is incorporated herein by reference for all purposes.

### BACKGROUND

### 1. Field of the Invention

One or more example embodiments relate to a deep neural network (DNN) learning accelerating apparatus and method, and more particularly, to a DNN learning accelerating apparatus and method for increasing an operation processing speed of DNN learning for deep reinforcement learning and improving energy efficiency.

### 2. Description of the Related Art

Deep reinforcement learning, which refers to a method of accelerating a neural network design by an autonomous agent using a trial and error algorithm of reinforcement learning and a cumulative reward function, may be performed by storing various experiences in new environments and corresponding rewards and updating a policy for determining behaviors to maximize the rewards.

This deep reinforcement learning may have desirable performance in applications requiring sequential determination in a new environment, such as, for example, a game agent, an automation robot, and the like. Deep reinforcement learning, which relates to the policy for determining behaviors, may exhibit great performance using a deep neural network (DNN), in particular.

Recently, various deep reinforcement learning technologies have been proposed. For example, Reference Document 1 discloses a deep reinforcement learning method that maximally efficiently uses experiences in a new environment using at least three DNNs, instead of using a single DNN.

However, deep reinforcement learning using these various types of DNNs may require frequent access to neural network weights and neuron data and a great amount of operation or computation for inference and learning of the DNNs. Accordingly, high-speed operations may not be readily performed on a user device, and power consumption may be high.

Most DNN operations used for deep reinforcement learning may include continuous convolutions or matrix multiplications of input neuron data and neural network weights. For the input neuron data and the neural network weights used for deep reinforcement learning, floating-point operations may be used to minimize an overflow and an underflow and thereby obtain high accuracy.

To reduce the amount of access to external memory for data that may be generated in such an operation process, Reference Document 2 discloses a method using a sparsity of input data, and Reference Document 3 discloses a method of compressing only an exponent part.

However, although these existing methods may be used to compress input neuron data of deep reinforcement learning, they may not be used to reduce a massive amount of access to neural network weights generated in a process of training various DNNs. Thus, the existing methods may have their limitations in accelerating an overall learning process of deep reinforcement learning.

There is also another technology for increasing the speed of deep reinforcement learning: compressing weights. Reference Document 4 discloses a method of sequentially pruning weights in each learning process, and Reference Document 5 discloses a method of grouping weights such that one weight value is used twice or more.

However, the method disclosed in Reference Document 4 may need to perform pruning less at an initial learning stage to maintain learning accuracy, and an initial learning compression rate may thus be reduced and the amount of time used for learning may thereby be increased. Also, the method disclosed in Reference Document 5 may have a degraded final accuracy of learning.

### PRIOR ART DOCUMENTS

### Non-Patent Documents

1. (Reference Document 1) S. Fujimoto, H. van Hoof, and D. Meger. Addressing function approximation error in actor-critic methods. In Proceedings of the 35th International Conference on Machine Learning, pages 1587-1596, 2018.
2. (Reference Document 2) S. Kang et al., “7.4 GANPU: A 135TFLOPS/W Multi-DNN Training Processor for GANs with Speculative Dual-Sparsity Exploitation,” 2020 IEEE International Solid-State Circuits Conference—(ISSCC), San Francisco, Calif., USA, 2020.
3. (Reference Document 3) C. Kim, S. Kang, D. Shin, S. Choi, Y. Kim and H. Yoo, “A 2.1TFLOPS/W Mobile Deep RL Accelerator with Transposable PE Array and Experience Compression,” 2019 IEEE International Solid-State Circuits Conference—(ISSCC), San Francisco, Calif., USA, 2019.
4. (Reference Document 4) M. Zhu and S. Gupta. To prune, or not to prune: exploring the efficacy of pruning for model compression. arXiv preprint arXiv:1710.01878, 2017.
5. (Reference Document 5) S. Liao and B. Yuan. Circconv: A structured convolution with low complexity. Proceedings of the AAAI Conference on Artificial Intelligence, 33(01):4287-4294, 2019.

### SUMMARY

An aspect of the present disclosure provides a deep neural network (DNN) learning accelerating apparatus and method that may increase an operation processing speed of DNN learning for deep reinforcement learning and improve energy efficiency, thereby enabling high-speed operations on a user device and reducing power consumption.

Another aspect of the present disclosure provides a DNN learning accelerating apparatus and method that may compress weights using a weight compression algorithm and train a DNN using the compressed weights, and may greatly reduce an external memory access bandwidth required for deep reinforcement learning and greatly reduce the number of required fixed-point operations and the number of accesses to internal memory, thereby increasing an overall operation processing speed and improving energy efficiency.

Still another aspect of the present disclosure provides a DNN learning accelerating apparatus and method that may apply weight grouping and sparsification to a weight training process of a DNN based on a floating-point operation and perform weight grouping and sparsification according to the progress of learning, thereby achieving a high compression rate in the overall training process of the DNN and increasing an operation processing speed while improving energy efficiency.

According to an example embodiment, there is provided a DNN learning accelerating apparatus for deep reinforcement learning, including: a DNN operation core configured to perform DNN learning for the deep reinforcement learning; and a weight training unit configured to train a weight parameter to accelerate the DNN learning and transmit the trained weight parameter to the DNN operation core, in which the weight training unit includes: a neural network weight memory configured to store therein the weight parameter; a neural network pruning unit configured to read the weight parameter from the neural network weight memory and perform weight pruning thereon, and store, back in the neural network weight memory, a sparse weight pattern generated as a result of the weight pruning; and a weight prefetcher configured to access the neural network weight memory and receive the sparse weight pattern, select/align only pieces of weight data of which values are not zero (0) from the neural network weight memory using the sparse weight pattern, and transmit, to the DNN operation core, the pieces of weight data of which the value are not zero.

According to another example embodiment, there is provided a DNN learning accelerating method for deep reinforcement learning, including: a weight training method determining step to determine a weight training method based on a sparsity ratio of a weight parameter that varies depending on a progress of learning; and a weight training step to train the weight parameter as per the determined weight training method, in which the weight training method determining step includes: selecting the weight training method to be a sparse weight training method when the sparsity ratio of the weight parameter exceeds a preset weight sparsity threshold; or otherwise, selecting the weight training method to be a group and sparse weight training method.

Additional aspects of example embodiments will be set forth in part in the description which follows and, in part, will be apparent from the description, or may be learned by practice of the disclosure.

According to the example embodiments described herein, a DNN learning accelerating apparatus and method may increase an operation processing speed of DNN learning for deep reinforcement learning and improve energy efficiency, thereby enabling high-speed operations on a user device and reducing power consumption.

According to the example embodiments described herein, a DNN learning accelerating apparatus and method may compress weights using a weight compression algorithm and train a DNN using the compressed weights, and may greatly reduce an external memory access bandwidth required for deep reinforcement learning and greatly reduce the number of required fixed-point operations and the number of accesses to internal memory, thereby increasing an overall operation processing speed while improving energy efficiency.

According to the example embodiments described herein, a DNN learning accelerating apparatus and method may apply weight grouping and sparsification to a weight training process of a DNN based on a floating-point operation and perform weight grouping and sparsification according to the progress of learning, thereby achieving a high compression rate in the overall training process of the DNN and increasing an operation processing speed while improving energy efficiency.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a schematic block diagram illustrating a deep neural network (DNN) learning accelerating apparatus for deep reinforcement learning according to an example embodiment;

FIG. 2 is a flowchart illustrating a DNN learning accelerating method for deep reinforcement learning according to an example embodiment;

FIG. 3 is a schematic flowchart illustrating a weight training method determining process according to an example embodiment;

FIG. 4 is a schematic flowchart illustrating a weight training process according to an example embodiment;

FIGS. 5A and 5B are diagrams illustrating a weight grouping process according to an example embodiment;

FIG. 6 is a schematic flowchart illustrating a weight pruning process according to an example embodiment; and

FIG. 7 is a schematic flowchart illustrating a reference value determining process according to an example embodiment.

### DETAILED DESCRIPTION

The following structural or functional descriptions of example embodiments described herein are merely intended for the purpose of describing the example embodiments described herein and may be implemented in various forms. Various modifications may be made to the example embodiments. Here, the example embodiments are not construed as limited to the disclosure and should be understood to include all changes, equivalents, and replacements within the idea and the technical scope of the disclosure.

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, elements, components, or the like, but do not preclude the presence or addition of one or more other features, elements, components, or the like.

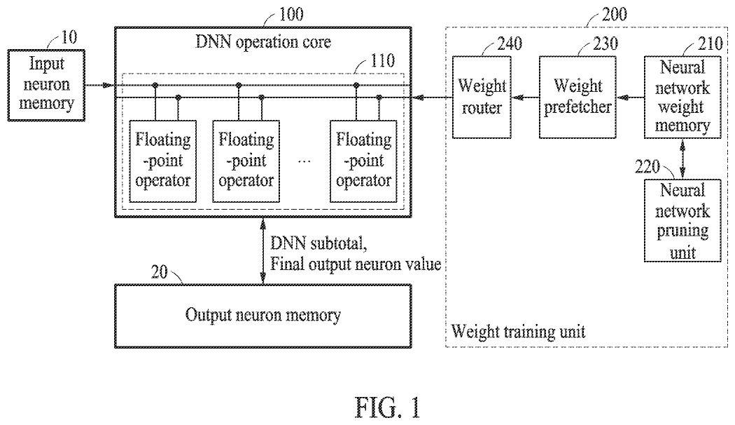

FIG. 1 is a schematic block diagram illustrating a deep neural network (DNN) learning accelerating apparatus for deep reinforcement learning according to an example embodiment. Referring to FIG. 1, the DNN learning accelerating apparatus for deep reinforcement learning may include a DNN operation core 100 and a weight training unit 200.

The DNN operation core 100 may receive input data from an input neuron memory 10 and perform DNN learning for deep reinforcement learning, and then output a result thereof to an output neuron memory 20. The DNN operation core 100 may perform a DNN operation at high speed by integrating several to several hundred floating-point operators 110 (also referred to as floating-point multiplier-accumulators) configured to process floating-point operations. In this case, the DNN operation core 100 may perform the DNN operation by receiving a weight parameter from a neural network weight memory 210 to be described hereinafter. The DNN operation core 100 may perform the DNN operation by receiving, from a weight prefetcher 230 to be described hereinafter, only pieces of weight data having values that are not zero (0).

That is, the input data retrieved from the input neuron memory 10 and the data received from a weight router 240 to be described hereinafter may be reusable through global or local connections between the floating-point operators 110 of the DNN operation core 100, and multiplication operations of which result values are predicted to be zero (0) based on data aligned by the weight prefetcher 230 may be skipped without being performed.

A DNN learning process used in deep reinforcement learning may be performed by iteratively performing forward propagation and backpropagation as a single unit process. Whenever the unit process is iteratively performed, weights may be updated such that better behavior is performed based on experiences achieved in a new environment. In the progress of the learning, significant weights for a final result may have large values, and insignificant weights for the final result may have small values. Such small weights may not need to be updated and may thus be removed through pruning, enabling weight compression. Such a series of processes described above may be referred to as weight training.

However, at an initial learning stage, updating may be performed using an initialized weight, and thus it may not be easy to determine which weight is significant and which weight is insignificant until a sufficient amount of time elapses. Therefore, a high pruning rate may not be applied.

Thus, for highly compressing weights at the initial learning stage, an additional weight compression method may need to be employed in addition to a “sparsity” through pruning. To this end, the weight training unit 200 may use a “grouped weight” method by which weights are divided into a plurality of groups based on a pre-determined structure and weights in the same group have the same value. That is, at the initial learning stage, the weight training unit 200 may perform sufficiently iteratively forward propagation and backpropagation including a floating-point operation-based DNN operation and an activation function operation, using the grouped weights, and then perform weight pruning to sequentially remove less significant weights.

However, continuously maintaining the grouped weights may reduce an overall neural network complexity, thereby reducing final accuracy. When a predetermined level has passed, it may be necessary to remove such a grouped weight structure.

At a final learning stage, the weight training unit 200 may apply “sparse weight training,” and perform sufficiently iteratively forward propagation and backpropagation without performing weight grouping, but performing weight pruning to sequentially remove less significant weights.

That is, the weight training unit 200 may train weight parameters as described above and transmit the trained weight parameters to the DNN operation core 100. In this case, the weight training unit 200 may apply both weight grouping and sparsification at the initial learning stage and may apply only weight sparsification at the final learning stage, thereby performing weight compression.

To this end, the weight training unit 200 may include the neural network weight memory 210, the neural network pruning unit 220, the weight prefetcher 230, and the weight router 240.

The neural network weight memory 210 may store therein weight parameters. For example, the neural network weight memory 210 may store therein weight parameter values updated during learning and weight parameters trained in the neural network pruning unit 220, in addition to initial weight parameter values.

The neural network pruning unit 220 may read the weight parameters from the neural network weight memory 210, perform weight pruning, and store, back in the neural network weight memory 210, a sparse weight pattern generated as a result of weight pruning.

To this end, the neural network pruning unit 220 may have a plurality of comparators integrated in parallel, and store a preset reference value for determining a target of pruning and compare, to the reference value, each of all data values included in the weight parameters. The neural network pruning unit 220 may then convert weight data having a value less than or equal to the reference value into sparse weight data (i.e., data having a value of zero (0)) and convert a weight parameter including the sparse weight data into a sparse pattern, performing pruning this way.

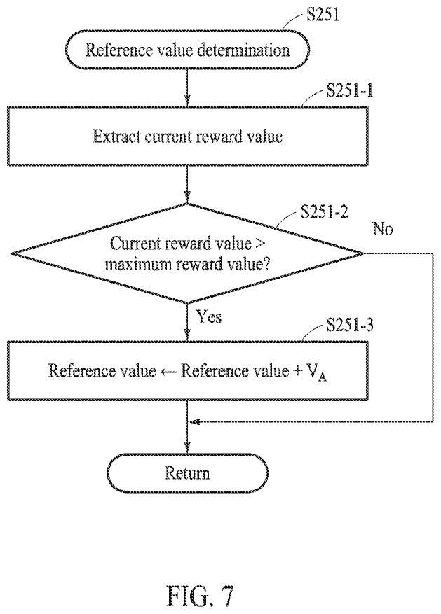

The reference value may be a value that is set in consideration of a reward value for deep reinforcement learning. The reference value may be generated in the neural network pruning unit 220, or a previously set reference value may be stored in the neural network pruning unit 220 to be used as the reference value afterward. A process of generating the reference value based on the reward value will be described below with reference to FIG. 7.

When the pruning is performed as described above, the neural network pruning unit 220 may store, in the neural network weight memory 210, weight parameters including remaining weights, excluding all pieces of weight data having the value of zero (0), and concurrently generate the sparse pattern and store also the generated sparse pattern in the neural network weight memory 210. In this case, the sparse pattern may be referred to by the weight prefetcher 230 to be described hereinafter.

For example, if a weight parameter is a 2×2 matrix

$$\vert \begin{matrix}31 \\ 24\end{matrix} \vert$$

and the reference value is 2.5, the neural network pruning unit 220 may convert 1 and 2 which are less than the reference value of 2.5 among pieces of weight data included in the weight parameter into sparse weight data (i.e., data having the value of zero (0)) to compress it in the form of

$$\vert \begin{matrix}30 \\ 04\end{matrix} \vert .$$

The neural network pruning unit 220 may then convert the compressed weight parameter into a sparse pattern

$$\vert \begin{matrix}10 \\ 01\end{matrix} \vert .$$

The neural network pruning unit 220 may perform pruning in this way as described above, and store both the compressed weight parameter

$$\vert \begin{matrix}30 \\ 04\end{matrix} \vert$$

and the sparse pattern

$$\vert \begin{matrix}10 \\ 01\end{matrix} \vert$$

in the neural network weight memory 210.

Before performing the weight pruning, the neural network pruning unit 220 may calculate a sparsity ratio with respect to the weight parameters stored in the neural network weight memory 210. In response to the sparsity ratio not exceeding a preset weight sparsity threshold, the neural network pruning unit 220 may further perform grouping to group multiple pieces of weight data included in each of multiple input/output channels included in the weight parameter.

The sparsity ratio refers to the number of pieces of sparse data (i.e., weight data having a value of zero) with respect to all pieces of weight data in a weight parameter in the form of a matrix including a plurality of pieces of weight data. For example, when a weight parameter is in the form of a 128×128 matrix, a total number of pieces of weight data included in the weight parameter is 16,384. In this example, when the number of pieces of weight data having a value of zero (0) among the total pieces of weight data is 8,192, the sparsity ratio is 50%.

The neural network pruning unit 220 may determine whether to perform weight grouping by comparing the sparsity ratio and a preset weight sparsity threshold. The weight sparsity threshold refers to a reference sparsity ratio value that is a criterion for determining a weight training method. For example, when the preset weight sparsity threshold is 60% and the calculated sparsity ratio is 50% as described above, the neural network pruning unit 220 may perform weight pruning after performing the grouping.

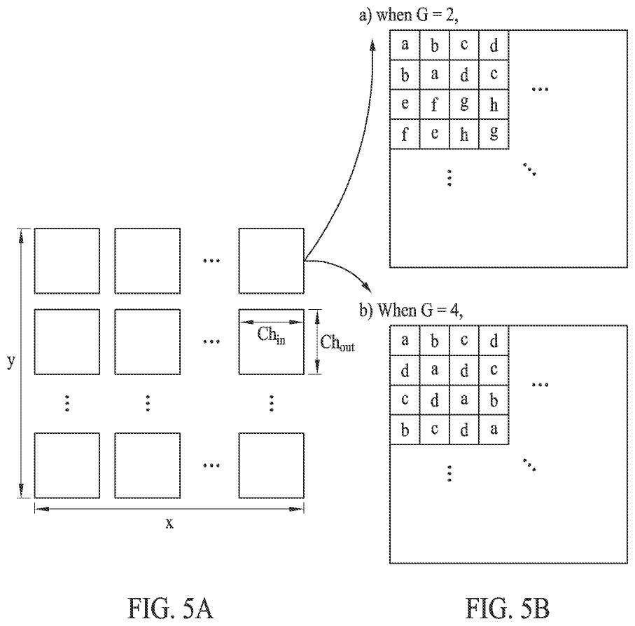

In this case, the neural network pruning unit 220 may determine the number of pieces of weight data to be grouped based on a group size preset for a weight parameter. For example, when the group size is 2, the neural network pruning unit 220 may groups two pieces of weight data. For another example, when the group size is 4, the neural network pruning unit 220 may group four pieces of weight data. The group size may be arbitrarily set or changed by a user according to characteristics of a neural network. A more detailed description of the grouping will be described below with reference to FIG. 5.

The weight prefetcher 230 may access the neural network weight memory 210 to receive the sparse weight pattern, and select/align only the pieces of weight data whose value is not zero (also be referred to as non-zero weight data) from the neural network weight memory 210 using the sparse weight pattern. The weight prefetcher 230 may then transmit the non-zero weight data to the DNN operation core 100.

The DNN operation core 100 may then maintain a speed of a neural network operation while omitting an operation on a weight having a value of zero, thereby achieving high throughput and high energy efficiency.

In this case, the weight prefetcher 230 may simultaneously transmit the aligned pieces of weight data and information on a position of a subtotal generated by the aligned pieces of weight data to the DNN operation core 100. This may be to allow the DNN operation core 100 to accurately recognize position information of each weight data, because the pieces of weight data aligned by the weight prefetcher 230 have an irregular order in a process of excluding the pieces of weight data whose value is zero. That is, through this, when a DNN operation occurs later, the DNN operation core 100 may realign the output subtotal or neuron data and store it in the output neuron memory 20.

The weight router 240, which is integrated to process grouped weights, may be configured as a router including a plurality of registers and multiplexers. When weights are grouped, the weight router 240 may enable data reuse within a group without additional access to the neural network weight memory 210. That is, the weight router 240 may store grouped pieces of weight data in the registers to reuse them, by receiving information on a group size and a group structure and storing it along with a corresponding weight in the registers. The weight router 240 may thereby allow the data that is once fetched from the neural network weight memory 210 to be reused multiple times.

The group size and the group structure may be information indicating a current weight grouping state, and the information may include a “group structure” indicating whether weights are grouped or not and a “group size” indicating the size of a group when weight grouping is applied. For example, the group structure may have a value of 1 when the weight grouping is applied or may have a value of 0 otherwise. In addition, when the group structure has the value of 1, the group size may have a value of 2 or 4.

For example, when a first weight of a group reaches the weight router 240, the weight router 240 may store the first weight in a register, along with information on a size and structure of the group, and simultaneously transmit the weight to the DNN operation core 100.

When the DNN operation core 100 requests data for a subsequent operation, the weight router 240 may adequately connect each floating-point operator 110 of the DNN operation core 100 and the weight router 240 based on the information on the size and structure of the that is to be transmitted together when the data is requested for the subsequent operation, without re-requesting the neural network weight memory 210 for a weight.

In this case, adequately connecting each floating-point operator 110 and the weight router 240 may indicate connecting them so as to calculate a correct output channel value. For example, when a group size is 2 and a weight value is used for an operation of generating a value of output channel 1, the same weight value may be used for an operation of generating a value of output channel 2 in a subsequent operation. However, in this example, since positions of output channels generated by all the floating-point operators 110 are different, the weight router 240 may initially connect the weight value to a floating-point operator 110 that calculates the output channel 1, and then connect the weight value to a floating-point operator 110 that calculates the output channel 2 in the subsequent operation.

The weight router 240 may reuse data fetched from memory by the number of times corresponding to a group size, thereby reducing the number of memory accesses and increasing energy efficiency for DNN operations.

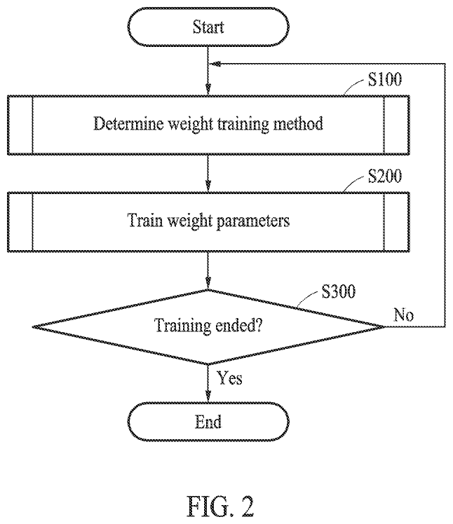

FIG. 2 is a flowchart illustrating a DNN learning accelerating method for deep reinforcement learning according to an example embodiment. The DNN learning accelerating method for deep reinforcement learning will be described in detail with reference to FIGS. 1 and 2.

In step S100, the weight training unit 200 may determine a weight training method. In general, DNN learning for deep reinforcement learning may be performed through weight training performed iteratively, for which the weight training unit 200 may determine the weight training method based on a sparsity ratio of a weight parameter that varies according to the progress of the learning in step S100.

The sparsity ratio refers to the number of pieces of sparse data (i.e., weight data having a value of zero (0)) to all pieces of weight data in a weight parameter in the form of a matrix including a plurality of pieces of weight data. For example, when a weight parameter is in the form of a 128×128 matrix, a total number of pieces of weight data included in the weight parameter is 16,384. In this example, when the number of pieces of weight data having the value of zero among the total pieces of weight data is 8,192, the sparsity ratio is 50%.

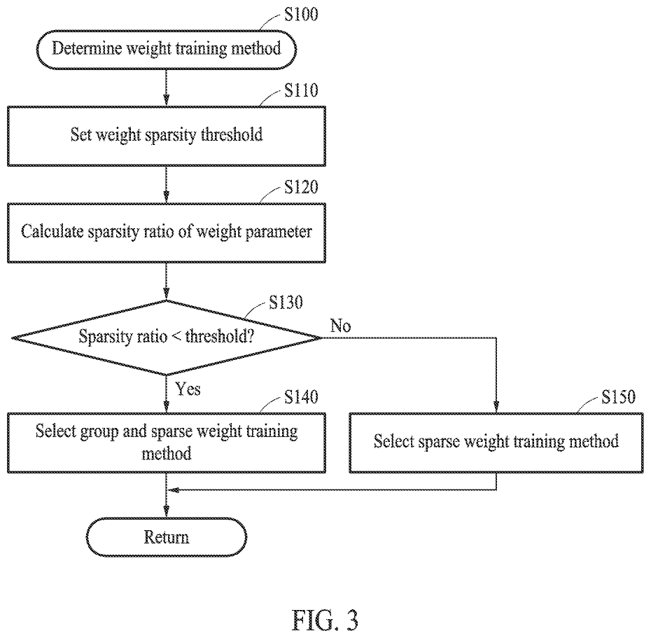

In step S100, the weight training unit 200 may determine the weight training method by comparing the sparsity ratio and a preset weight sparsity threshold. The weight sparsity threshold refers to a reference sparsity ratio value that is a criterion for determining the weight training method. An example of such weight training method determining step S100 is illustrated in FIG. 3.

FIG. 3 is a schematic flowchart illustrating a weight training method determining process according to an example embodiment. Referring to FIGS. 1 through 3, in step S110, the weight training unit 200 may set a weight sparsity threshold to determine a weight training method. The weight sparsity threshold may be set by changing based on a network type or user input information.

In step S120, the weight training unit 200 may calculate a sparsity ratio of a weight parameter. That is, in step S120, the weight training unit 200 may count the number of pieces of weight data having a value of zero among all pieces of weight data included in the weight parameter, and calculate a ratio of the pieces of weight data having the value of zero to all the pieces of weight data included in the weight parameter.

In step S130, the weight training unit 200 may compare the weight sparsity threshold set in step S110 and the sparsity ratio of the weight parameter calculated in step S120.

In steps S140 and S150, the weight training unit 200 may determine the weight training method based on a comparison result obtained in step S130. In this case, the weight training unit 200 may select a group and sparse weight training method in step S140 when the sparsity ratio is less than the threshold, and select a sparse weight training method in step S150 when the sparsity ratio is greater than or equal to the threshold.

For example, if the threshold is 50% and the calculated sparsity ratio is less than 50%, the weight training unit 200 may select the group and sparse weight training method to which both weight grouping and sparsification are applied, or otherwise may select the sparse weight training method to which only the weight sparsification is applied.

The weight training method may be determined differently based on the sparsity ratio as described above. This may be because updating is performed with an initialized weight at an initial learning stage and thus which weights are significant and which weights are insignificant may not be determined until a sufficient period of time elapses, and there may be thus a limitation in compressing weights through pruning based on the sparsity ratio. Accordingly, when the weight grouping is continuously maintained throughout the learning, the overall neural network complexity may decrease and the final accuracy may thus be degraded.

Therefore, as illustrated in FIG. 3, it may be desirable to select the weight training method to which both the grouping and the sparsification are applied at the initial learning stage with a low sparsity ratio, and select the weight training method to which only the sparsification is applied when the sparsity ratio becomes greater than or equal to a specific value (i.e., the threshold) as a sufficient period of time elapses in the learning. In this way, the DNN learning accelerating method described herein may achieve a high weight compression rate in all the processes of learning without compromising the learning accuracy.

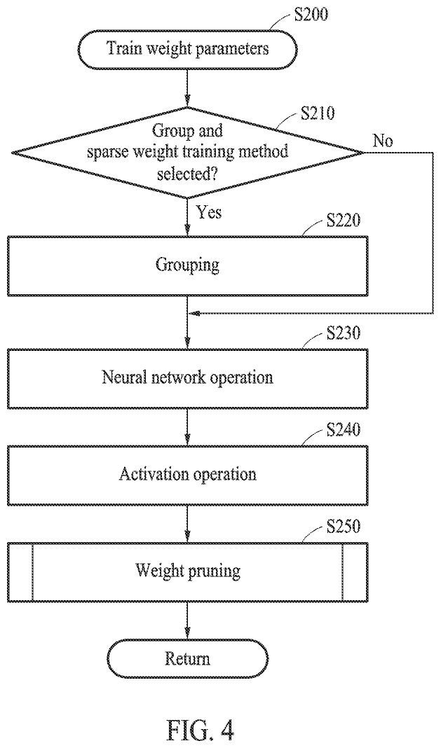

In step S200, the weight training unit 200 may train the weight parameter. For example, the weight training unit 200 may train the weight parameter based on the weight training method determined in step S100. An example of such a weight training process S200 is illustrated in FIGS. 4 through 7, and the weight training process S200 will be described in detail with reference to FIGS. 4 through 7.

In step S300, the weight training unit 200 may determine whether a training end condition is satisfied, and iteratively perform steps S100 and S200 until the training end condition is satisfied. The training end condition may include the absence of input data that is newly input from the input neuron memory 10, the preset training time, or the like.

FIG. 4 is a schematic flowchart illustrating a weight training process according to an example embodiment. Referring to FIGS. 1, 2 and 4, the weight training process S200 may be as follows.

In step S210, the weight training unit 200 may determine whether to perform a grouping step S220 by verifying the weight training method selected in step S100. When the weight training method selected in step S100 is a group and sparse weight training method as the result of the verifying in step S210, the weight training unit 200 may proceed to step S220 to perform grouping, or otherwise may proceed to a subsequent step without performing step S220.

In step S220, the weight training unit 200 may group a plurality of pieces of weight data included in each input/output channel, for each of input/output channels included in the weight parameter. In step S220, the weight training unit 200 may determine the number of pieces of weight data to be grouped based on a group size preset with respect to the weight parameter. For example, if the group size is 2, the weight training unit 200 may group two pieces of weight data, and if the group size is 4, the weight training unit 200 may group four pieces of weight data. The group size may be arbitrarily set or changed by a user according to characteristics of a neural network.

FIGS. 5A and 5B are diagrams illustrating a weight grouping process according to an example embodiment. Referring to FIGS. 1, and 5A and 5B, the weight training unit 200 may perform grouping on an input channel and an output channel as illustrated in FIGS. 5A and 5B. For example, when performing the grouping on a weight having an input channel Chin, an output channel Chout, a horizontal kernel length x, a vertical kernel length y, and a group size G, the weight training unit 200 may perform the grouping separately on input channels and output channels for each kernel position. FIG. 5A illustrates examples of a four-dimensional (4D) weight parameter, and FIG. 5B illustrates an example of performing the grouping individually on the input channels and the output channels. For example, the group size G is 2 in a case (a) illustrated in FIG. 5B, and the group size G is 4 in a case (b) illustrated in FIG. 5B.

Referring to (a) of FIG. 5B, when the group size G is 2, the grouping may be performed by dividing the input channels and the output channels into quadrangles having a size of 22 to have the same weight in the form of a circulant matrix in each quadrangle. In addition, referring to (b) of FIG. 5B, when the group size G is 4, the grouping may be performed by dividing the input channels and the output channels into quadrangles having a size of 42 to have the same weight in the form of a circular matrix in each quadrangle.

Referring back to FIGS. 1, 2, and 4, in step S230, the weight training unit 200 may perform a neural network operation. That is, in step S230, the weight training unit 200 may perform a floating-point DNN operation, except for sparse weight data (i.e., data having a value of zero (0)) that determines a sparsity ratio among all pieces of data included in a weight parameter.

In step S240, the weight training unit 200 may convert a result of the neural network operation obtained in step S230 into an output signal by an activation function.

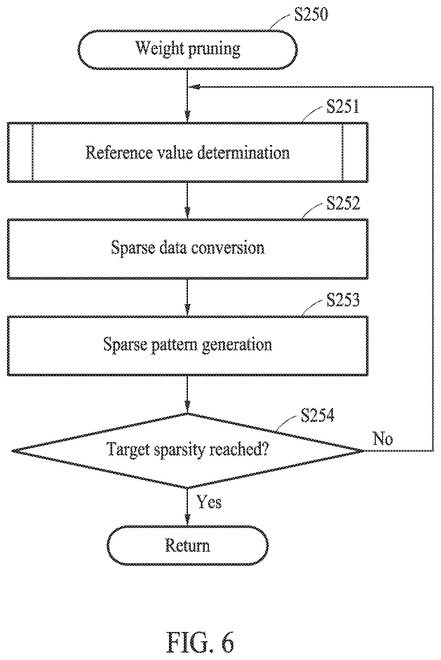

In step S250, the weight training unit 200 may perform weight pruning on a result of the activation operation obtained in step S240. For example, the weight training unit 200 may iteratively perform the weight pruning until a preset target sparsity is satisfied. An example of the weight pruning step S250 is illustrated in FIG. 6.

FIG. 6 is a schematic flowchart illustrating a weight pruning process according to an example embodiment. Referring to FIG. 6, the weight pruning step S250 may be performed as follows.

In step S251, the weight training unit 200 may determine a reference value for determining whether each of all pieces of data included in the weight parameter is a target of pruning. The reference value may be determined based on a reward value for deep reinforcement learning. The reference value, which is a value set based on the reward value for the deep reinforcement learning, may be generated in the neural network pruning unit 220 or use a preset reference value stored in the neural network pruning unit 220.

FIG. 7 is a schematic flowchart illustrating a reference value determining process according to an example embodiment. Referring to FIG. 7, the reference value determining step S251 may be performed as follows.

In step S251-1, the weight training unit 200 may extract a current reward value. That is, in step S251-1, the weight training unit 200 may extract a reward value (i.e., the current reward value) generated through current reinforcement learning.

In step S251-2, the weight training unit 200 may compare the current reward value and a maximum reward value among previous reward values generated through the deep reinforcement learning.

In step S251-3, the weight training unit 200 may generate a new reference value based on a result of the comparing performed in step S251-2. That is, in step S251-3, when the current reward value extracted in step S251-1 is greater than the previous maximum reward value, the weight training unit 200 may generate the new reference value by increasing the reference value by a preset increment value VA. In this case, the increasing of the reference value by the preset increment value VA may be performed because the current reward value is greater than the maximum reward value and it is available to perform the weight pruning more. By increasing the reference value gradually, it is possible to perform the weight pruning while maintaining the accuracy of the deep reinforcement learning.

Referring back to FIG. 6, in step S252, the weight training unit 200 may convert the weight pruning target among all the pieces of data included in the weight parameter into sparse data based on the determined reference value. That is, in step S252, the weight training unit 200 may compare each of all the pieces of data included in the weight parameter to the reference value and convert data having a value less than or equal to the reference value into sparse weight data (i.e., data having a value of zero (0)).

In step S253, the weight training unit 200 may convert the weight parameter including the sparse weight data into a sparse pattern.

In step S254, the weight training unit 200 may determine whether the sparsity ratio of the sparse pattern reaches a preset target sparsity. When it is determined as a result of the determining performed in step S254 that the sparsity ratio of the sparse pattern does not reach the preset target sparsity, the weight training unit 200 may iteratively perform steps S251 through S253.

For example, if the weight parameter is a 2×2 matrix

$$\vert \begin{matrix}31 \\ 24\end{matrix} \vert$$

and the reference value is 2.5, the pruning may be performed in the weight pruning step S250 in the following way: converting, into sparse weight data (e.g., data having a value of zero (0)), data having values 1 and 2 that are less than the reference value 2.5 among all the pieces of weight data included in the weight parameter; compressing the sparse weight data into the form of

$$\vert \begin{matrix}30 \\ 04\end{matrix} \vert ;$$

and converting the compressed weight parameter into a sparse pattern

$$\vert \begin{matrix}10 \\ 01\end{matrix} \vert .$$

However, in the weight pruning step S250, when the target sparsity is not reached even by increasing the reference value, the weight training unit 200 may iteratively perform a process (e.g., steps S251 through S253) of generating the sparse pattern while increasing the reference value until the target sparsity is reached, by returning to the beginning. Accordingly, the weight pruning may be performed in sequential order as described herein to prevent a phenomenon in which a considerably large number of weight values are fixed to zero (0) and prevent rapid degradation of learning accuracy.

In addition, the group size G required for weight grouping and the reference value increment VA in an algorithm for determining a reference value based on a reward may be arbitrarily determined by a user or be obtained using a method of searching an available range in advance and finding a reference value for a high level of accuracy and a high speed.

By applying what has been descried above to deep reinforcement learning, it may be possible to compress approximately 60 to 70% of weights on average in the overall learning process. For example, TD3 in Mujoco Humanoid-v2, TD3 in Mujoco Halfcheetah-v2, and PPO in Google Research Football may achieve approximately 66.1%, 72.0%, and 73.6% of weight compression with almost the same accuracy.

In addition, the deep reinforcement learning may be performed using a DNN learning accelerator. For example, training TD3 in Mujoco-Humanoid-v2 may improve the energy efficiency by a factor of 4.4 times and the learning speed by a factor of 2 times.

While this disclosure includes example embodiments, it will be apparent to one of ordinary skill in the art that various changes in form and details may be made in these example embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A deep neural network (DNN) learning accelerating apparatus for deep reinforcement learning, comprising:
a DNN operation core configured to perform DNN learning for the deep reinforcement learning; and
a weight training unit configured to train a weight parameter to accelerate the DNN learning and transmit the trained weight parameter to the DNN operation core,
wherein the weight training unit comprises:
a neural network weight memory configured to store therein the weight parameter;
a neural network pruning unit configured to read the weight parameter from the neural network weight memory and perform weight pruning thereon, and store, back in the neural network weight memory, a sparse weight pattern generated as a result of the weight pruning; and
a weight prefetcher configured to access the neural network weight memory and receive the sparse weight pattern, select/align only pieces of weight data of which values are not zero (0) from the neural network weight memory using the sparse weight pattern, and transmit, to the DNN operation core, the pieces of weight data of which the value are not zero.

2. The DNN learning accelerating apparatus of claim 1, wherein the weight prefetcher is configured to:
simultaneously transmit, to the DNN operation core, the aligned pieces of weight data and information on a position of a subtotal generated by the aligned pieces of weight data.

3. The DNN learning accelerating apparatus of claim 2, wherein the DNN operation core is configured to:
perform a DNN operation at high speed by arranging, in parallel, a plurality of multiplier-accumulators configured to process a floating-point operation, wherein the DNN operation core is configured to perform the DNN operation by receiving, from the weight prefetcher, only the pieces of weight data of which the values are not zero.

4. The DNN learning accelerating apparatus of claim 3, wherein, before performing the weight pruning, the neural network pruning unit is further configured to:
calculate a sparsity ratio of the weight parameter with respect to weight parameters stored in the neural network weight memory; and
in response to the sparsity ratio not exceeding a preset weight sparsity threshold, further perform grouping a plurality of pieces of weight data comprised in each input/output channel of multiple input/output channels comprised in the weight parameter.

5. The DNN learning accelerating apparatus of claim 4, further comprising:
a weight router configured as a router comprising a plurality of registers and multiplexers and configured to store the grouped pieces of weight data to reuse the grouped pieces of weight data.

6. A deep neural network (DNN) learning accelerating method for deep reinforcement learning, comprising:
a weight training method determining step to determine a weight training method based on a sparsity ratio of a weight parameter that varies depending on a progress of learning; and
a weight training step to train the weight parameter as per the determined weight training method,
wherein the weight training method determining step comprises:
selecting the weight training method to be a sparse weight training method when the sparsity ratio of the weight parameter exceeds a preset weight sparsity threshold, or otherwise, selecting the weight training method to be a group and sparse weight training method.

7. The DNN learning accelerating method of claim 6, wherein the sparse weight training method comprises:
a neural network operation step of performing a floating-point DNN operation, excluding sparse weight data that determines the sparsity ratio among all pieces of data comprised in the weight parameter;
an activation operation step of converting a result of the neural network operation step into an output signal by an activation function; and
a weight pruning step of performing weight pruning on a result of the activation operation step until a preset target sparsity is satisfied.

8. The DNN learning accelerating method of claim 7, wherein the group and sparse weight training method comprises:
a grouping step of grouping a plurality of pieces of weight data comprised in each input/output channel of multiple input/output channels comprised in the weight parameter, before performing the weight training step as per the sparse weight training method,
wherein the grouping step comprises:
determining the number of pieces of weight data to be grouped based on a group size preset for the weight parameter.

9. The DNN learning accelerating method of claim 8, wherein the weight pruning step comprises:
a reference value determining step of determining a reference value used to determine a target of the pruning, for each of all pieces of data comprised in the weight parameter, based on a reward value for the deep reinforcement learning;
a sparse data converting step of comparing each of all the pieces of data comprised in the weight parameter to the reference value, and converting, into sparse weight data, data having a value less than or equal to the reference value; and
a sparse pattern generating step of converting a weight parameter comprising the sparse weight data into a sparse pattern,
wherein, until a sparsity ratio of the sparse pattern reaches a preset target sparsity, the reference value determining step, the sparse data converting step, and the sparse pattern generating step are performed iteratively.

10. The DNN learning accelerating method of claim 9, wherein the reference value determining step comprises:
when a current reward value extracted from current reinforcement learning is greater than a previous maximum reward value, generating a new reference value by increasing the reference value by a preset increment value.
